(19) United States
(12) Patent Application Publication
(10) Pub. No.: US 2022/0243913 A1
(43) Pub. Date: Aug. 4, 2022

(54) Closed-loop Control System, Method and Device for Intelligent Soot Blowing of Utility Boiler

(71) Applicant: Shandong Shang'ao Power Technology Co., Ltd., Jinan City (CN)

(72) Inventors: Jie Dong, Jinan City (CN); Shuang Dong, Jinan City (CN); Ruixin Dong, Jinan City (CN)

(21) Appl. No.: 17/502,535

(22) Filed: Oct. 15, 2021

(30) Foreign Application Priority Data
Feb. 2, 2021 (CN) 202110173387.0

(51) Int. Cl. F23J 3/02

(52) U.S. Cl. CPC F23J 3/02; G06F 3/04847

(57) ABSTRACT

A closed-loop control system for intelligent soot blowing of a utility boiler is provided, including an intelligent soot blowing server, a distributed control system, a physical isolation device, a client and a heating surface soot blower group, where the intelligent soot blowing server communicates with the DCS via the physical isolation device, reads data from the DCS, and sends a soot blowing alarm signal or a soot blowing control signal to the DCS after processing the data; the client and the heating surface soot blower group establish communication links with the DCS separately; a program and a control flow of the closed-loop control system for intelligent soot blowing is developed; a time protection soot blowing flow for a heating surface of an air pre-heater is set in the control flow; a screen of the closed-loop control system for intelligent soot blowing is set up and installed in the DCS.

### CROSS REFERENCE TO RELATED APPLICATION

This patent application claims the benefit and priority of Chinese Patent Application No. 202110173387.0 filed on Feb. 2, 2021, the disclosure of which is incorporated by reference herein in its entirety as part of the present application.

### TECHNICAL FIELD

The present disclosure relates to the field of energy saving reconstruction and information control of a pulverized coal boiler, and in particular to a closed-loop control system, method and device for intelligent soot blowing of a pulverized coal type utility boiler.

### BACKGROUND ART

Pulverized coal type utility boilers generally suffer from soot deposition and slag formation during operation due to their large capacity. The soot deposition and slag formation may in turn cause both high temperature and low temperature corrosion to the boilers while adversely affecting the heat-exchanging effect and operation efficiency of the boilers, which increases a chance of tube bursting on heating surfaces of the boilers, shortens a service life of the boilers and has an impact on safe operation of the boilers. In view of the above fact, the pulverized coal type utility boilers are all equipped with numerous soot blowers to blow soot either regularly according to operational experience or in shift, which is prone to excessive blowing or insufficient blowing of the heating surfaces. In recent years, owing to a development of information technology, intelligent soot blowing has been applied to the pulverized coal type utility boilers. The intelligent soot blowing enables targeted soot blowing according to soot pollution situations of the different heating surfaces of the boilers. In other words, the heavily polluted heating surfaces are subjected to strengthened soot blowing, and the lightly polluted heating surfaces are subjected to less frequent soot blowing or no soot blowing. However, most of the existing intelligent soot blowing technologies stagnate at such a stage that pollution on the heating surfaces of the boiler is monitored and judged, a pollution and soot blowing alarm signal is sent out, and then an operator further performs soot blowing determination and soot blowing operations according to the alarm signal. In the case of some so-called closed-loop control systems and methods for intelligent soot-blowing, the alarm signal is only sent out by means of a controller or used to control the soot blowers directly without any further scientific processing, which leads to a poor practicability and may even cause boiler soot-blowing accidents.

### SUMMARY

Embodiments of the present disclosure provide a closed-loop control system, method and device for intelligent soot blowing of a utility boiler. According to an intelligent soot blowing alarm signal, in combination with conditions of heating surfaces of the utility boiler and equipment configuration, closed-loop control logic for the intelligent soot blowing of the utility boiler is researched and developed. The applicability of guiding boiler soot blowing by the intelligent soot blowing alarm signal is enhanced, and the degree of automation of intelligent soot blowing and unit operation safety are improved. Problems that existing intelligent soot blowing is still at a stage characterized by soot blowing alarm and is poor in applicability are solved, and advantages that the intelligent soot blowing alarm signal is circularly detected, soot blowing for the heating surface of the boiler is sorted, closed-loop control and manual control are combined, and soot blowing operation is secured are realized.

A closed-loop control system, method and device for intelligent soot blowing of a utility boiler includes an intelligent soot blowing server, a distributed control system (DCS), a physical isolation device, a client and a heating surface soot blower group, where the intelligent soot blowing server communicates with the DCS via the physical isolation device, reads data from the DCS, and sends a soot blowing alarm signal or a soot blowing control signal to the DCS after processing the data; the client and the heating surface soot blower group establish communication links with the DCS separately; a program and a control flow of the closed-loop control system for intelligent soot blowing are developed; the program is installed in an intelligent soot blowing server or in the DCS, a time protection soot blowing flow for a heating surface of an air pre-heater is set in the control flow; a screen of the closed-loop control system for intelligent soot blowing is set up and installed in the DCS; and cyclic detection of an intelligent soot blowing alarm signal, sequential, cyclic and full-automatic closed-loop control and manual control of soot blowing for the heating surface soot blower group, and double safety control of soot blowing on the heating surface of the air pre-heater are realized by interaction between the screen and the program of the closed-loop control system for intelligent soot blowing, thereby realizing safe and efficient operation of the intelligent soot blowing of the boiler.

The set-up screen of the closed-loop control system for intelligent soot blowing may include: an alarm screen for a heating surface of a water wall located in a hearth, alarm screens for heating surfaces of a wall type reheater or a wall type superheater, a platen or division panel superheater, a rear platen or secondary superheater and a rear platen or secondary reheater which are located at top of the hearth, alarm screens for heating surfaces of a high-temperature or final superheater and a high-temperature or final reheater which are located at a horizontal flue, alarm screens for heating surfaces of a low-temperature or primary reheater, a low-temperature or primary superheater, an economizer or a primary economizer, a secondary economizer and a tertiary economizer and the air pre-heater which are located at a tail shaft flue, a soot blowing operation interactive screen and a flue gas flow direction sign; in the soot blowing operation interactive screen, soot blowing alarm labels and alarm lights of the heating surfaces are separately set, engagement and disengagement buttons are set behind the corresponding alarm lights, and the engagement and disengagement buttons for all the heating surfaces are set; when the alarm light of the heating surface gives an alarm, the corresponding heating surface changes in color synchronously to raise an alarm; in the soot blowing operation interactive screen, labels and alarm lights for an initial condition, a soot blower setting, intelligent soot blowing operation, and an intelligent soot blowing fault, start and reset buttons, a main steam valve and an auxiliary steam valve, labels, valve symbols, draining time displays and draining temperature displays of drain valves corresponding to the heating surfaces are further set; the set engagement and disengagement buttons, the start and reset buttons, and the valve symbols can be operated in advance or online in real time by clicking a mouse to interact with the program of the closed-loop control system for intelligent soot blowing, to realize working state switching between engagement and disengagement, start and reset, and opening and closing of a valve; and the buttons and the valves in a working state change in color to be differentiated from the buttons in a non-working state. In the utility boiler, a large number of steam soot blowers, including short blowing, long blowing and half-long blowing soot blowers, may be arranged on the water wall and each heating surface area, and shock wave or gas pulse soot blowers may be arranged in a tail flue. And the heating surface soot blower group is grouped according to a position of a soot blower in the boiler and a soot blowing effect on the heating surface and includes an air pre-heater heating surface soot blower group, a water wall heating surface soot blower group, a wall type reheater or wall type superheater heating surface soot blower group, a platen or division panel superheater heating surface soot blower group, a rear platen or secondary superheater heating surface soot blower group, a rear platen or secondary reheater heating surface soot blower group, a high-temperature or final superheater heating surface soot blower group, a high-temperature or final reheater heating surface soot blower group, a low-temperature or primary reheater heating surface soot blower group, a low-temperature or primary superheater heating surface soot blower group, and an economizer or primary economizer, secondary economizer and tertiary economizer heating surface soot blower group.

The control flow of the closed-loop control system for intelligent soot blowing is based on a boiler structure and a heating surface setting, according to a sequence of the heating surface of the air pre-heater, the heating surface of the water wall, the heating surfaces of the wall type reheater or wall type superheater, the platen or division panel superheater, the rear platen or secondary superheater, and the rear platen or secondary reheater, the heating surfaces of the high-temperature or final superheater and the high-temperature or final reheater, and the heating surfaces of the low-temperature or primary reheater, the low-temperature or primary superheater, and the economizer or the primary economizer, the secondary economizer and the tertiary economizer, control over a soot blowing alarm signal retrieval module, a soot blower group engagement confirmation module, a module for soot blowing pipeline heating temperature or draining time setting and drain valve closing after draining, a soot blowing pressure and soot blowing time setting module, a heating surface soot blower starting module, and a heating surface soot blower valve fault determination module is sequentially performed, to realize the soot blowing alarm signal retrieval, the soot blowing determination, and engagement operation of the heating surface soot blower group for all the heating surfaces according to the flue gas flow direction of the boiler, with the heating surfaces which do not meet an operation load condition, a valve opening and an alarm condition being skipped, so as to realize sequential control of the intelligent soot blowing for all the heating surfaces; and after soot blowing of the last heating surface, which is the heating surface of the economizer or the primary economizer, the secondary economizer and the tertiary economizer, is skipped or finished, the soot blowing alarm signal retrieval for all the heating surfaces is performed again by the program, and a next flow of alarm signal sequential detection, determination and soot blowing operation for all the heating surfaces is sequentially performed according to the soot blowing alarm signal of the heating surface, to realize cyclic control of the intelligent soot blowing.

In the control flow of the closed-loop control system for intelligent soot blowing, after the flow of alarm signal sequential detection, determination and soot blowing operation for all the heating surfaces is completed, an air pre-heater heating surface time protection soot blowing flow is started, to realize the double safety protection of soot blowing on the heating surface of the air pre-heater.

In the soot blowing operation interactive screen, under a condition that the start button is set to be constantly in a working state, buttons for all the heating surfaces are set in an engagement state, the engagement button for each heating surface after the soot blowing alarm is set in a working state, and the soot blower setting is completed in advance, sequential, cyclic, safe and full-automatic closed-loop control of soot blowing for all the heating surfaces can be realized, otherwise, man-machine interactive control can be realized; and the program control flow of soot blowing with the auxiliary steam valve is consistent with a control flow of soot blowing with the main steam valve.

The set-up control flow of the closed-loop control system for intelligent soot blowing may include the following steps:

S1, start of the program of the closed-loop control system for intelligent soot blowing: clicking on the start button in the soot blowing operation interactive screen to start the program, or clicking on the reset button to restore the program to an initial condition;

S2, initial condition detection: performing the initial condition detection after starting the program, where the initial condition includes whether or not soot blowers corresponding to all the heating surfaces are in situ, whether or not the main steam valve and the auxiliary steam valve are closed at the exact position, whether or not drain valves of soot blower pipelines corresponding to all the heating surfaces are opened at the exact position, and that no other equipment fault alarm signals exist except the soot blowing alarm signal; when the initial condition is met, the alarm light for the initial condition is turned on, and the program proceeds to the next step, and when the initial condition is not met, the alarm light for the initial condition is turned off, and an operator checks the initial condition;

S3, soot blower setting: reminding, when the alarm light for the soot blower setting is turned on, the operator to perform the soot blower setting, to disengage the heating surface soot blower group that is faulty or does not need soot blowing; and proceeding to the next step by the program after reminding time t>m s, where the time m is determined according to a specific number of the soot blowers of the boiler and requirements of the operator, and is programmed in advance;

S4, engagement of an all-heating-surfaces button or an alarm-heating-surface button: proceeding, when the button is in an engagement state, to the next step of the program, or stopping the program when the button is in a disengagement state;

S5, the soot blowing alarm signal retrieval for all the heating surfaces: proceeding with the program when there are one or more heating surfaces send out the soot blowing alarm signals at the same time in the screen, and otherwise stopping the program;

S6, determination of working states of the soot blowers for all the heating surfaces: proceeding with the program when there is an alarm signal but no heating surface subjected to soot blowing, and otherwise stopping the program;

S7, reconfirmation of the start button and the engagement button of the closed-loop control program for intelligent soot blowing: defaulting, by the program, to the previous operation states of the start and engagement buttons; resetting the closed-loop control program for intelligent soot blowing when the reset button is manually operated; and enabling the corresponding heating surface to be in the disengagement state without soot blowing when the disengagement button for all the heating surfaces or the disengagement button for the alarm heating surface is operated;

S8, operation load determination: proceeding with the program when an operation load meets a load set condition, and otherwise stopping the program, where the load set condition and a maximum continuous rating are determined in advance and programmed according to a unit condition and a requirement;

S9, opening of the main steam valve: automatically opening the main steam valve by default when the operation load meets the set condition, and proceeding with the program, where the main steam valve can further be manually opened or closed via the mouse;

S10, main steam valve valve-fault determination module, including an interrupt processing and resetting flow: performing the interrupt processing and resetting after manual processing when there is a fault; and proceeding with the program when there is no fault;

S11, setting of a drain pressure of the main steam valve: as programmed in advance according to an operation requirement, setting the drain pressure of the main steam valve as 0.8 MPa, 0.9 MPa, 1.0 MPa or 1.1 MPa, or setting the drain pressure of the main steam valve by manually clicking on the valve symbol of the main steam valve during operation;

S12, detection of an air pre-heater alarm signal: firstly detecting, by the program, an air pre-heater heating surface alarm signal, continuing after confirmation of detection, and otherwise skipping an air pre-heater heating surface soot blowing flow, which indicates that the heating surface is not subjected to soot blowing;

S13, confirmation of the engagement of the air pre-heater heating surface soot blower group: reading, by the program, the engagement or disengagement state of the air pre-heater heating surface soot blower group; proceeding with the program when the air pre-heater heating surface soot blower group is in the engagement state, and skipping, by the program, a soot blowing flow for the heating surface when the air pre-heater heating surface soot blower group is in the disengagement state; where the engagement and disengagement buttons behind an air pre-heater alarm in the soot blowing operation interactive screen may be operated in advance or online;

S14, performing, by the program, a module for an air pre-heater soot blowing pipeline heating temperature or draining time setting and drain valve closing after draining, where the heating temperature or the draining time of the air pre-heater soot blowing pipeline can be set and programmed in advance according to a design requirement and can be modified online in real time; a draining completion signal is sent after draining is completed, the program automatically controls and closes the drain valve of the soot blowing pipeline; in the soot blowing operation interactive screen, the draining time and a draining temperature are displayed behind a draining time sign and a draining temperature sign correspondingly, and color change is displayed when the drain valve is opened or closed;

S15, performing, by the program, a module for an air pre-heater soot blowing pressure and soot blowing time setting; proceeding with the program when the soot blowing pressure of the air pre-heater meets a requirement, and otherwise stopping the program, where the soot blowing pressure and the soot blowing time of the air pre-heater can be set in the program in advance according to the requirement or set online in real time;

S16, performing, by the program, a module for an air pre-heater heating surface soot blower group soot blowing starting; automatically starting, by the program, a valve of an air pre-heater soot blower group to perform the soot blowing sequentially, and finishing the soot blowing and continuing by the program after the soot blowing is performed for the set soot blowing time;

S17, determination of operation load and main steam valve opened at the exact position: proceeding to the next step of the program when the operation load meets a set condition and a main steam valve opening meets a requirement, and otherwise skipping, by the program, soot blowing flows for all the heating surfaces and closing the main steam valve, where the load set condition and a maximum continuous rating (MCR) can be determined in advance and programmed according to the unit condition and the design requirement;

S18, retrieval for a water wall heating surface soot blowing alarm signal and no soot blowing on the other heating surfaces: continuing, by the program, a soot blowing flow of the heating surface when there is the soot blowing alarm signal on the heating surface of the water wall and the other heating surfaces are not subjected to soot blowing, and otherwise skipping, by the program, the soot blowing flow of the heating surface;

S19, confirmation of the engagement of a water wall heating surface soot blower group: reading, by the program, the engagement or disengagement state of the water wall heating surface soot blower group, determining whether or not the water wall heating surface soot blower group is in an engagement soot blowing state; performing, by the program, a corresponding soot blowing flow of the heating surface when the water wall heating surface soot blower group is in the engagement state, otherwise skipping, by the program, the soot blowing flow of the heating surface; where the engagement and disengagement buttons behind a heating surface alarm may be manually operated in advance and may further be operated online in real time in the soot blowing operation interactive screen;

S20, performing, by the program, a module for a water wall soot blowing pipeline heating temperature or draining time setting and drain valve closing after draining, where the heating temperature or the draining time of the water wall soot blowing pipeline can be set and programmed in advance according to a design requirement and can be modified online in real time; a draining completion signal is sent after draining is completed, the program automatically controls and closes the drain valve of the water wall soot blowing pipeline; in the soot blowing operation interactive screen, the draining time and a draining temperature are displayed behind a draining time sign and a draining temperature sign correspondingly, and color change is displayed when the drain valve is opened or closed;

S21, performing, by the program, a module for a water wall soot blowing pressure and soot blowing time setting: continuing, by the program, a soot blowing flow of the heating surface when the soot blowing pressure of the water wall meets a requirement, and otherwise stopping the program; where the soot blowing pressure and the soot blowing time of the water wall can be set in the program in advance according to the requirement or set online in real time;

S22, performing, by the program, a module for a water wall heating surface soot blower group starting: automatically starting, by the program, a valve of the corresponding soot blower group to perform the soot blowing sequentially, and finishing the soot blowing and proceeding with the program after the soot blowing is performed for the soot blowing time;

S23, performing, by the program, a module for a water wall heating surface soot blower valve fault determination: determining whether the valve of the heating surface soot blower is faulty, performing the interrupt processing and resetting after the processing when there is a fault, and finishing soot blowing for the heating surface of the water wall and then proceeding with the program when there is no fault;

S24, retrieval for a wall type reheater or wall type superheater heating surface soot blowing alarm signal and no soot blowing on the other heating surfaces: performing, by the program, a corresponding flow of the heating surface soot blower group when there is the soot blowing alarm signal on the heating surface of the wall type reheater or the wall type superheater while the other heating surfaces are not subjected to soot blowing, and otherwise skipping, by the program, the soot blowing flow of the heating surface;

after S24, the control flow further includes steps between retrieval for the wall type reheater or wall type superheater heating surface soot blowing alarm signal and no soot blowing on the other heating surfaces and retrieval for an economizer or primary economizer, secondary economizer and tertiary economizer heating surface soot blowing alarm signal and no soot blowing on the other heating surfaces, including: steps of the soot blowing control flows for the heating surfaces and steps between every two heating surfaces of the wall type reheater or wall type superheater, the platen or division panel superheater, the rear platen or secondary superheater, the rear platen or secondary reheater, the high-temperature or final superheater, the high-temperature or final reheater, the low-temperature or primary reheater, and the low-temperature or primary superheater; the control flow of the soot blowing program for each heating surface is consistent with the control flow of the soot blowing program for the heating surface of the water wall, but relevant parameters for the soot blowing pipeline heating temperature or draining time setting, the soot blowing pressure and soot blowing time setting and flow abnormality in the flow, as well as control signals for the drain valves, the soot blowers and a soot blower fault, should be replaced with those of the corresponding heating surfaces;

S25, retrieval for an economizer or primary economizer, secondary economizer and tertiary economizer heating surface soot blowing alarm signal and no soot blowing on the other heating surfaces: performing, by the program, a corresponding soot blowing flow of the heating surface when there is the soot blowing alarm signal on the heating surface of the economizer or primary economizer, secondary economizer and tertiary economizer while the other heating surfaces are not subjected to soot blowing, and otherwise skipping, by the program, the soot blowing flow of the heating surface to retrieve the soot blowing alarm signals for all the heating surfaces;

S26, confirmation of the engagement of an economizer or primary economizer, secondary economizer and tertiary economizer heating surface soot blower group: continuing, by the program, a corresponding soot blowing flow for the heating surface when the engagement is confirmed, and otherwise skipping, by the program, the soot blowing flow of the heating surface;

S27, performing, by the program, a module for an economizer or primary economizer, secondary economizer and tertiary economizer soot blowing pipeline heating temperature or draining time setting and drain valve closing after draining, which is similar as S20;

S28, performing, by the program, a module for an economizer or primary economizer, secondary economizer and tertiary economizer soot blowing pressure and soot blowing time setting, which is similar as S21;

S29, performing, by the program, a module for an economizer or primary economizer, secondary economizer and tertiary economizer soot blower group starting, which is similar as S22;

S30, performing, by the program, a module for an economizer or primary economizer, secondary economizer and tertiary economizer heating surface soot blower valve fault determination, which is similar as S23;

S31, retrieval for the soot blowing alarm signals for all the heating surfaces: performing S12 by the program when there are one or more heating surfaces send out the soot blowing alarm signals at the same time, that is, performing the detection of the air pre-heater alarm signal again to realize intelligent soot blowing cyclic detection and determination, and otherwise entering, by the program, an air pre-heater time protection soot blowing flow, including S32 to S36;

S32, a module for determining a soot blowing time interval between a last soot blowing and a current soot blowing of the air pre-heater: performing the soot blowing flow for the heating surface of the air pre-heater when the time interval is greater than a set time interval, and otherwise skipping the soot blowing flow of the heating surface, where the soot blowing time interval can be set in advance according to a condition, for example, can be set as 14400 s, 21600 s, 28800 s, etc.;

S33, performing, by the program, a module for confirming the engagement of the air pre-heater heating surface soot blower group, which is consistent with S13;

S34, performing, by the program, the module for the air pre-heater soot blowing pipeline heating temperature or draining time setting and drain valve closing after draining, which is consistent with S14;

S35, performing, by the program, the module for the air pre-heater soot blowing pressure and soot blowing time setting, which is consistent with S15;

S36, performing, by the program, the module for the air pre-heater heating surface soot blower group soot blowing starting, which is consistent with S16;

S37, closing the main steam valve by the program: automatically closing the main steam valve by the program when there is no heating surface alarm, time of soot blowing for the air pre-heater does not go beyond the set time interval, no air pre-heater heating surface soot blower group is engaged, the operation load does not meet a set condition, and the main steam valve is not opened at the exact position;

S38, performing the main steam valve valve-fault determination module, which is consistent with S10;

S39, performing, by the program, a flow of closing the main steam valve at the exact position and opening drain valves of soot blowing pipelines of all the heating surfaces: sending, by the program, an instruction of closing at the exact position to the main steam valve, determining a state of closing at the exact position, and opening the drain valves of the soot blowing pipelines of all the heating surfaces after the main steam valve is closed at the exact position; and

S40, performing a drain valve valve-fault determination module: determining whether there are the valve faults on the drain valves of the soot blowing pipelines of all the heating surfaces; performing the interrupt processing and resetting after the processing when there is the fault; opening the drain valve when there is no fault or after resetting, to complete a first-round control flow of the closed-loop control system for intelligent soot blowing, then the program returns to the start state, to form a closed-loop control flow of the control system for intelligent soot blowing.

### BRIEF DESCRIPTION OF THE DRAWINGS

FIG. 1 is a screen of a closed-loop control system for intelligent soot blowing according to an embodiment of the present disclosure.

FIG. 2 is a schematic diagram of network connection according to an embodiment of the present disclosure.

FIG. 3 is a control flow chart of a program of the closed-loop control system for intelligent soot blowing according to an embodiment of the present disclosure.

### DETAILED DESCRIPTION OF THE EMBODIMENTS

Embodiments of the present disclosure are provided below to deepen the understanding of the present disclosure. These embodiments are merely illustrative of the present disclosure and do not limit the scope of the present disclosure.

The present disclosure is further described with reference to the drawings according to embodiments of the present disclosure.

The embodiments of the present disclosure provide a closed-loop control system, method and device for intelligent soot blowing of a utility boiler. According to an intelligent soot blowing alarm signal, in combination with conditions of heating surfaces of the utility boiler and equipment configuration, closed-loop control logic for the intelligent soot blowing of the utility boiler is researched and developed. The applicability of guiding boiler soot blowing by the intelligent soot blowing alarm signal is enhanced, and the degree of automation of intelligent soot blowing and unit operation safety are improved. Problems that existing intelligent soot blowing is still at a stage characterized by soot blowing alarm and is poor in applicability are solved, and advantages that the intelligent soot blowing alarm signal is circularly detected, soot blowing for the heating surface of the boiler is sorted, closed-loop control and manual control are combined, and soot blowing operation is secured are realized.

The embodiment of the closed-loop control system, method and device for intelligent soot blowing of the utility boiler provided by the present disclosure includes an intelligent soot blowing server 201, a distributed control system (DCS) 203, a physical isolation device 202, a client 205 and a heating surface soot blower group 204, where the intelligent soot blowing server 201 communicates with the DCS 203 via the physical isolation device 202, reads data from the DCS, and sends a soot blowing alarm signal or a soot blowing control signal to the DCS after processing the data; the client 205 and the heating surface soot blower group 204 establish communication links with the DCS 203 separately; a program and a control flow of the closed-loop control system for intelligent soot blowing are developed; the program is installed on the intelligent soot blowing server or in the DCS; a time protection soot blowing flow for a heating surface of an air pre-heater is set in the control flow; a screen of the closed-loop control system for intelligent soot blowing is set up and installed in the DCS; and cyclic detection of an intelligent soot blowing alarm signal, sequential, cyclic and full-automatic closed-loop control and manual control of soot blowing for the heating surface soot blower group 204, and double safety control of soot blowing on the heating surface of the air pre-heater are realized by interaction between the screen and the program of the closed-loop control system for intelligent soot blowing, thereby realizing safe and efficient operation of the intelligent soot blowing of the boiler.

The set-up screen of the closed-loop control system for intelligent soot blowing may include: an alarm screen for a heating surface of a water wall 101 located in a hearth, alarm screens for heating surfaces of a wall type reheater or a wall type superheater 102, a platen or division panel superheater 103, a rear platen or secondary superheater 104 and a rear platen or secondary reheater 105 which may be located at a top of the hearth, alarm screens for heating surfaces of a high-temperature or final superheater 106 and a high-temperature or final reheater 107 which may be located at a horizontal flue, alarm screens for heating surfaces of a low-temperature or primary reheater 108, a low-temperature or primary superheater 109, an economizer or a primary economizer, a secondary economizer and a tertiary economizer 110 and the air pre-heater 111 which may be located at a tail shaft flue, as well as a soot blowing operation interactive screen 112 and a flue gas flow direction sign; in the soot blowing operation interactive screen 112, soot blowing alarm labels and alarm lights of the heating surfaces are separately set, engagement and disengagement buttons are set behind the corresponding alarm lights, and the engagement and disengagement buttons for all the heating surfaces are set; when the alarm light of the heating surface gives an alarm, the corresponding heating surface changes in color synchronously to raise an alarm; in the soot blowing operation interactive screen, labels and alarm lights for an initial condition, a soot blower setting, intelligent soot blowing operation, and an intelligent soot blowing fault, start and reset buttons, a main steam valve (MSV) and an auxiliary steam valve (ASV), labels, valve symbols, draining time displays and draining temperature displays of drain valves corresponding to the heating surfaces are further set; the set engagement and disengagement buttons, the start and the reset buttons, and the valve symbols can be operated in advance or online in real time by clicking a mouse to interact with the program of the closed-loop control system for intelligent soot blowing, to realize working state switching between engagement and disengagement, start and reset, and opening and closing of a valve; and the buttons and the valves in a working state change in color to be differentiated from the buttons in a non-working state.

The control flow of the closed-loop control system for intelligent soot blowing may be based on a boiler structure and a heating surface setting, according to a sequence of the heating surface of the air pre-heater 111, the heating surface of the water wall 101, the heating surface of the wall type reheater or wall type superheater 102, the platen or division panel superheater 103, the rear platen or secondary superheater 104, the rear platen or secondary reheater 105, the heating surface of the high-temperature or final superheater 106 and the high-temperature or final reheater 107, and the heating surface of the low-temperature or primary reheater 108, the low-temperature or primary superheater 109, and the economizer or primary economizer, secondary economizer and tertiary economizer 110, control over a soot blowing alarm signal retrieval module, a soot blower group engagement confirmation module, a module for soot blowing pipeline heating temperature or draining time setting and drain valve closing after draining, a soot blowing pressure and soot blowing time setting module, a heating surface soot blower starting module, and a heating surface soot blower valve fault determination module is sequentially performed, to realize the soot blowing alarm signal retrieval, the soot blowing determination, and engagement operation of the heating surface soot blower group for all the heating surfaces according to the flue gas flow direction of the boiler, with the heating surfaces which do not meet an operation load condition, a valve opening and an alarm condition being skipped, so as to realize sequential control of the intelligent soot blowing for all the heating surfaces; and after soot blowing of the last heating surface, which is the heating surface of the economizer or the primary economizer, the secondary economizer and the tertiary economizer, is skipped or finished, the soot blowing alarm signal retrieval for all the heating surfaces is performed again by the program, and a next flow of alarm signal sequential detection, determination and soot blowing operation for all the heating surfaces is sequentially performed according to the soot blowing alarm signal of the heating surface, to realize cyclic control of the intelligent soot blowing.

In the control flow of the closed-loop control system for intelligent soot blowing, after the flow of alarm signal sequential detection, determination and soot blowing operation for all the heating surfaces is completed, an air pre-heater heating surface time protection soot blowing flow is started, to realize the double safety protection of soot blowing on the heating surface of the air pre-heater.

In the soot blowing operation interactive screen, under a condition that the start button is set to be constantly in a working state, buttons for all the heating surfaces are set in an engagement state, the engagement button for each heating surface after the soot blowing alarm is set in a working state, and the soot blower setting is completed in advance, sequential, cyclic, safe and full-automatic closed-loop control of soot blowing for all the heating surfaces can be realized, otherwise, man-machine interactive control can be realized; and the program control flow of soot blowing with the auxiliary steam valve (ASV) is consistent with a control flow of soot blowing with the main steam valve (MSV).

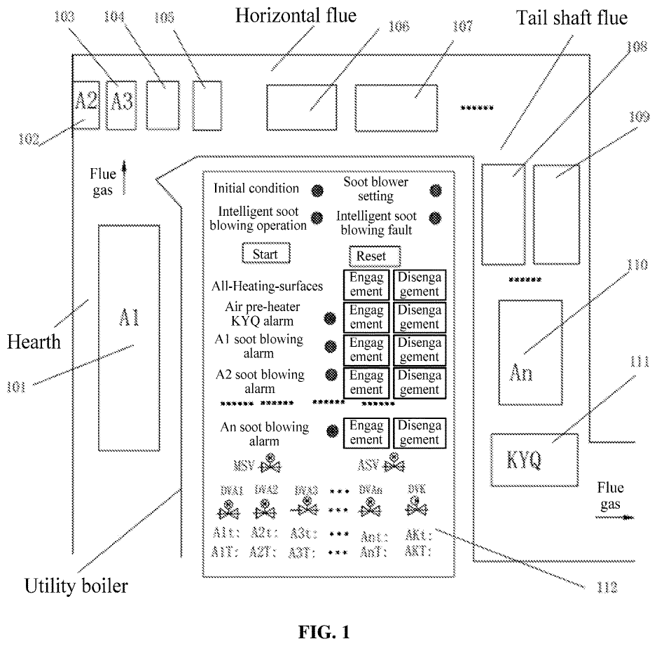

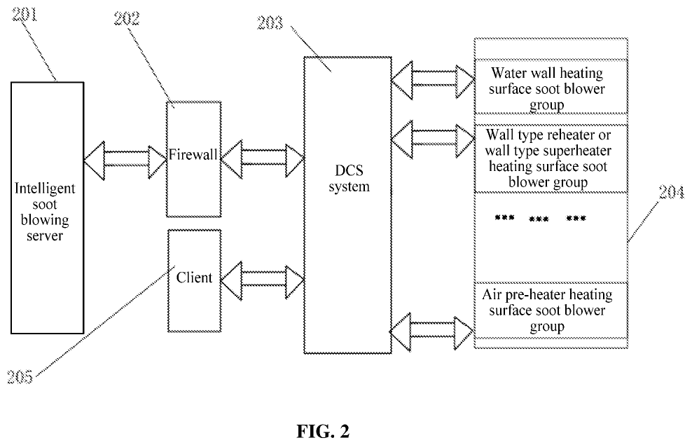

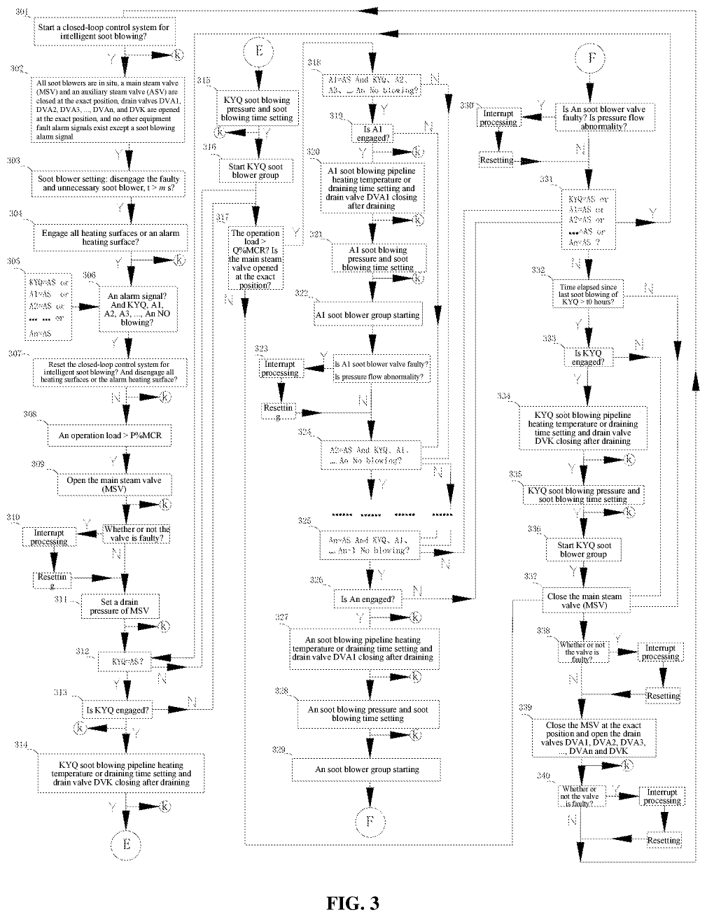

For convenience of explanation, in the control flow chart of the program of the closed-loop control system for intelligent soot blowing showing in FIG. 3 and the screen of the closed-loop control system for intelligent soot blowing showing in FIG. 1 according to embodiments of the present disclosure, the heating surface of the water wall, the heating surface of the wall type reheater or wall type superheater, the heating surface of the platen or division panel superheater, the heating surface of the rear platen or secondary superheater, the heating surface of the rear platen or secondary reheater, the heating surface of the high-temperature or final superheater, the heating surface of the high-temperature or final reheater, the heating surface of the low-temperature or primary reheater, the heating surface of the low-temperature or primary superheater, the heating surface of the economizer or primary economizer, secondary economizer and tertiary economizer and the heating surface of the air pre-heater may be indicated by symbols A1, A2, A3, . . . , An, and KYQ in a unified mode, the drain valves on the soot blowing pipelines corresponding to the above-mentioned heating surfaces may be marked with symbols DVA1, DVA2, DVA3, . . . , DVAn and DVK correspondingly, and the draining time displays and the draining temperature displays corresponding to the above-mentioned heating surfaces may be marked with symbols A1t, A2t, A3t, . . . , Ant and AKt as well as A1T, A2T, A3T, . . . , AnT and AKT correspondingly; “Y” may indicate “yes” or “confirmation”, “N” may indicate “no”, (K) may indicate that the engagement and disengagement buttons may be manually operated, (E) and (F) may indicate connection of the control flow, “ . . . ” may indicate that steps of the control flow may be omitted due to similarity or repetition, “→” may indicate a direction of the control flow or a flue gas flow direction in the screen of the closed-loop control system for intelligent soot blowing; and the auxiliary steam valve (ASV) may be started during auxiliary steam soot blowing. In the utility boiler, a large number of steam soot blowers, including short blowing, long blowing and half-long blowing soot blowers, may be arranged on the water wall and each heating surface area, and shock wave or gas pulse soot blowers may be arranged in a tail flue. And in the schematic diagram of network connection according to one embodiment of the present disclosure showing in FIG. 2, the heating surface soot blower groups 204 may be grouped according to positions of soot blowers and soot blowing effects on the heating surfaces and includes an air pre-heater heating surface soot blower group, a water wall heating surface soot blower group, a wall type reheater or wall type superheater heating surface soot blower group, a platen or division panel superheater heating surface soot blower group, a rear platen or secondary superheater heating surface soot blower group, a rear platen or secondary reheater heating surface soot blower group, a high-temperature or final superheater heating surface soot blower group, a high-temperature or final reheater heating surface soot blower group, a low-temperature or primary reheater heating surface soot blower group, a low-temperature or primary superheater heating surface soot blower group, and an economizer or primary economizer, secondary economizer and tertiary economizer heating surface soot blower group, which may be replaced with a KYQ soot blower group, an A1 soot blower group, . . . , and an An soot blower group sequentially in the control flow chart showing in FIG. 3.

The set-up control flow of the closed-loop control system for intelligent soot blowing, as shown in FIG. 3, may include the following steps S1-S40.

S1 implemented by a control unit 301: “Start a closed-loop control system for intelligent soot blowing?”. Specifically, the start button in the soot blowing operation interactive screen is clicked on to start the program, or the reset button is clicked on to restore the program to an initial condition.

S2 implemented by a control unit 302: initial condition detection. Specifically, the initial condition detection is performed after starting the program, where the initial condition may include whether or not soot blowers corresponding to all the heating surfaces are in situ, whether or not the main steam valve (MSV) and the auxiliary steam valve (ASV) are closed at the exact position, whether or not drain valves DVA1, DVA2, DVA3, . . . , DVAn, and DVK are opened at the exact position, and that no other equipment fault alarm signals exist except the soot blowing alarm signal. When the initial condition may be met, the alarm light for the initial condition may be turned on, and the program may proceed to the next step. And when the initial condition may be not met, the alarm light for the initial condition may be turned off, and an operator may check the initial condition.

S3 implemented by a control unit 303: “Soot blower setting: disengage the faulty and unnecessary soot blower, t>m s?” Specifically, when the alarm light for the soot blower setting may be turned on, the operator is reminded to perform the soot blower setting, to disengage the heating surface soot blower group that may be faulty or does not need soot blowing; and the program proceeds to the next step after reminding time t>m s. The time m may be determined according to the specific number of the soot blowers of the boiler and requirements of the operator, and may be programmed in advance;

S4 implemented by a control unit 304: “Engage an all-heating-surfaces button or an alarm-heating-surface button?” Specifically, when the button may be in an engaged state, the program proceeds to the next step; when the button may be in a disengagement state, the program is stopped. The button may be operated in advance or online in real time.

S5 implemented by a control unit 305: the soot blowing alarm signal retrieval for all the heating surfaces. Specifically, the program may proceed to the next step when there are one or more heating surfaces send out the soot blowing alarm signals at the same time in the screen; where “KYQ=AS or A1=AS, A2=AS, A3=AS, . . . , An=AS” may indicate that there are one or more heating surfaces that may send out the soot blowing alarm signals at the same time, that is, the soot blowing alarm signal retrieval for all the heating surfaces.

S6 implemented by a control unit 306: determination of working states of the soot blowers for all the heating surfaces. Specifically, when there are “an alarm signal? and KYQ, A1, A2, A3, . . . , An NO blowing”, which may indicate that there is the alarm signal but no heating surface subjected to soot blowing, the determination of working states of the soot blowers for all the heating surfaces is performed.

S7 implemented by a control unit 307: reconfirmation of the start button and the engagement button of the closed-loop control program for intelligent soot blowing. Specifically, the program may default the previous operation states of the start and engagement buttons. The closed-loop control program for intelligent soot blowing is reset when the reset button is manually operated; and the corresponding heating surface is in the disengagement state without soot blowing when the disengagement button for all the heating surfaces or the disengagement button for the alarm heating surface is operated.

S8 implemented by a control unit 308: operation load determination. Specifically, the program may proceed to the next step when an operation load meets a condition, and otherwise the program is stopped. The “operation load>P % MCR” may indicate the operation load determination, that is, when the operation load may be greater than a set percentage of a maximum continuous rating, the load condition may be deemed to be met. P and the maximum continuous rating (MCR) may be determined in advance and programmed according to a unit condition and requirement.

S9 implemented by a control unit 309: “Open the main steam valve (MSV)”. Specifically, when the operation load meets the condition, the main steam valve (MSV) may be automatically opened by default, and the program may proceed to the next step. The main steam valve (MSV) may further be manually opened or closed by means of the mouse.

S10 implemented by a control unit 310: main steam valve valve-fault determination module, including an interrupt processing and resetting. Specifically, the valve fault of the main steam valve (MSV) may be automatically detected and determined. The interrupt processing is performed and resetting is performed after manual processing when there is a fault; and the program is continued when there is no fault.

S11 implemented by a control unit 311: “Set a drain pressure of MSV”. The drain pressure of the main steam valve may be programmed in advance according to an operation requirement, and set as 0.8 MPa, 0.9 MPa, 1.0 MPa or 1.1 MPa, or further be set by manually clicking on the valve symbol of MSV during operation.

S12 implemented by a control unit 312: detection of an air pre-heater alarm signal. Specifically, the program may firstly detect an air pre-heater heating surface alarm signal, and the program may be continued after confirmation of detection, and otherwise the program may skip an air pre-heater heating surface soot blowing flow, which indicates that the heating surface may be not subjected to soot blowing. “KYQ=AS?” may indicate the detection of an air pre-heater alarm signal.

S13 implemented by a control unit 313: confirmation of the engagement of the air pre-heater heating surface soot blower group. Specifically, the program may read the engaged or disengaged state of the air pre-heater heating surface soot blower group, and the program may continue the soot blowing flow for the heating surface when the air pre-heater heating surface soot blower group may be in the engaged state, and the program may skip the soot blowing flow for the heating surface when the air pre-heater heating surface soot blower group may be in the disengagement state. “Is KYQ engaged?” may indicate a request to confirm whether or not the air pre-heater heating surface soot blower group may be engaged.

S14 implemented by a control unit 314: a module for a KYQ soot blowing pipeline heating temperature or draining time setting and drain valve DVK closing after draining performed by the program. The heating temperature and the draining time of the KYQ soot blowing pipeline may be set and programmed in advance according to a design requirement and may be modified online in real time. A draining completion signal may be sent after draining is completed, the program may automatically control and close the drain valve DVK of the soot blowing pipeline. In an alarm screen, the draining time and a draining temperature may be displayed behind AKt and AKT correspondingly, color change may be displayed when the drain valve DVK is opened or closed, and KYQ may indicate the heating surface of the air pre-heater.

S15 implemented by a control unit 315: a module for a KYQ soot blowing pressure and soot blowing time setting performed by the program. Specifically, the program may continue the soot blowing flow of the heating surface when the soot blowing pressure of the air pre-heater meets a set requirement. The soot blowing pressure and the soot blowing time of the air pre-heater may be set in the program in advance according to the requirement or set online in real time.

S16 implemented by a control unit 316: a module for starting KYQ soot blower group to soot blowing, performed by the program. Specifically, the program may automatically start a valve of an air pre-heater soot blower group to perform the soot blowing sequentially, and finish the soot blowing and then perform the next step after the soot blowing may be performed for the set soot blowing time.

S17 implemented by a control unit 317: “the operation load>Q % MCR? is the main steam valve opened at the exact position?” may indicate the determination of operation load and main steam valve (MSV) opened at the exact position. Specifically, the program may proceed to S18 when the operation load and an opening degree of the main steam valve may meet a requirement, and otherwise the program may skip soot blowing flows for all the heating surfaces and closes the main steam valve (MSV). Q % MCR may indicate the percentage of the maximum continuous rating. Q and the maximum continuous rating (MCR) may be determined in advance and programmed according to the unit condition and a design requirement.

S18 implemented by a control unit 318: retrieval for a water wall heating surface soot blowing alarm signal and no soot blowing on the other heating surfaces. Specifically, the program may continue the soot blowing flow of the heating surface when there is the soot blowing alarm signal on the heating surface of the water wall and the other heating surfaces are not subjected to soot blowing, and otherwise the program may skip the soot blowing flow of the heating surface. “A1=AS AND KYQ, A2, A3, . . . , An NO blowing?” may indicate the retrieval for a water wall heating surface soot blowing alarm signal and no soot blowing on the other heating surfaces.

S19 implemented by a control unit 319: confirmation of the engagement of a water wall heating surface soot blower group. Specifically, the program may read the engaged or disengaged state of the water wall heating surface soot blower group, and determine whether or not the water wall heating surface soot blower group is in an engaged soot blowing state. The program may perform a corresponding soot blowing flow of the heating surface when the water wall heating surface soot blower group is in the engaged state, otherwise the program may skip the soot blowing flow of the heating surface. “Is A1 engaged?” may indicate a request for the confirmation of the engagement of a water wall heating surface soot blower group. And the engagement and disengagement buttons behind the heating surface alarm may be set in advance in the soot blowing operation interactive screen, and may further be confirmed online in real time.

S20 implemented by a control unit 320: a module for A1 soot blowing pipeline heating temperature or draining time setting and drain valve DVA1 closing after draining, performed by the program. The heating temperature and the draining time of the water wall heating surface soot blowing pipeline may be set and programmed in advance according to a design requirement and may be modified online in real time. A draining completion signal may be sent after draining is completed, and the program may automatically control and close the drain valve DVA1 of a water wall soot blowing pipeline. In the soot blowing operation interactive screen, the draining time and a draining temperature may be displayed behind A1t and A1T correspondingly, and color change may be displayed when the drain valve DVA1 is opened or closed.

S21 implemented by a control unit 321: a module for A1 soot blowing pressure and soot blowing time setting, performed by the program. Specifically, in the water wall soot blowing pressure and soot blowing time setting, the soot blowing pressure and the soot blowing time for the heating surface of the water wall may be set in the program in advance according to the requirement or set online in real time. When the soot blowing pressure of the water wall may meet a set requirement, the program may continue a soot blowing flow of the heating surface.

S22 implemented by a control unit 322: an A1 soot blower group starting module. Specifically, the program may automatically start the water wall heating surface soot blower group to perform soot blowing sequentially, and finish soot blowing and perform the next step of the program after the soot blowing is performed for a set soot blowing time.

S23 implemented by a control unit 323: “Is A1 soot blower valve faulty? Is pressure flow abnormality?” that is, a module for a water wall heating surface soot blower valve fault determination, performed by the program. Specifically, the interrupt processing is performed and then resetting is performed after the processing when there is the fault, and the program may continue when there is no fault.

S24 implemented by a control unit 324: “A2=AS AND KYQ, A1, A3, . . . , An NO blowing?” performed by the program, indicating retrieval for a wall type reheater or wall type superheater heating surface soot blowing alarm signal and no soot blowing on the other heating surfaces. Specifically, the program may perform a corresponding flow of the heating surface soot blower group when there is the soot blowing alarm signal on the heating surface of the wall type reheater or the wall type superheater and the other heating surfaces are not subjected to soot blowing, and otherwise the program may skip the soot blowing flow of the heating surface.

After S24, the control flow may further include steps between retrieval for the wall type reheater or wall type superheater heating surface soot blowing alarm signal and no soot blowing on the other heating surfaces and retrieval for an economizer or primary economizer, secondary economizer and tertiary economizer heating surface soot blowing alarm signal and no soot blowing on the other heating surfaces, including: steps of the soot blowing control flows for the heating surfaces and steps between every two heating surfaces of the wall type reheater or wall type superheater, the platen or division panel superheater, the rear platen or secondary superheater, the rear platen or secondary reheater, the high-temperature or final superheater, the high-temperature or final reheater, the low-temperature or primary reheater, and the low-temperature or primary superheater. The control flow of the soot blowing program for each heating surface is consistent with the control flow of the soot blowing program for the heating surface of the water wall, but relevant parameters for the soot blowing pipeline heating temperature or draining time setting, the soot blowing pressure and soot blowing time setting and flow abnormality in the flow, as well as control signals for the drain valves, the soot blowers and a soot blower fault, should be replaced with those of the corresponding heating surface. To avoid repetition, “ . . . ” may be used in the drawings to indicate omission of some consistent steps.

S25 implemented by a control unit 325: “An=AS AND KYQ, A1, A2, . . . , An−1 NO blowing?” performed by the program, that is, retrieval for an economizer or primary economizer, secondary economizer and tertiary economizer heating surface soot blowing alarm signal and no soot blowing on the other heating surfaces. Specifically, the program may perform a corresponding soot blowing flow of the heating surface when there is the soot blowing alarm signal on the heating surface and the other heating surfaces are not subjected to soot blowing, and otherwise the program may skip the soot blowing flow of the heating surface to retrieve the soot blowing alarm signals for all the heating surfaces.

S26 implemented by a control unit 326: a determination module for “Is An engaged?” performed by the program, that is, confirmation of the engagement of an economizer or primary economizer, secondary economizer and tertiary economizer heating surface soot blower group. Specifically, the program may continue a corresponding soot blowing flow for the heating surface upon confirmation of the engagement, and otherwise the program may skip the soot blowing flow of the heating surface soot blower group to retrieve the soot blowing alarm signals for all the heating surfaces.

S27 implemented by a control unit 327: the program proceeds with a module for “An soot blowing pipeline heating temperature or draining time setting and drain valve DVAn closing after draining”, that is, a flow of an economizer or primary economizer, secondary economizer and tertiary economizer soot blowing pipeline heating temperature or draining time setting and drain valve closing after draining, which is similar as S20, is performed. The DVAn may indicate the drain valve of the heating surface soot blowing pipeline.

S28 implemented by a control unit 328: the program proceeds with a module for “An soot blowing pressure and soot blowing time setting”, that is, a module for an economizer or primary economizer, secondary economizer and tertiary economizer soot blowing pressure and soot blowing time setting, which is similar as S21, is performed.

S29 implemented by a control unit 329: a module for “An soot blower group starting” is performed by the program, that is, a module for an economizer or primary economizer, secondary economizer and tertiary economizer soot blower starting, which is similar as S22, is performed.

S30 implemented by a control unit 330: a determination module for “Is An soot blower valve faulty? Is pressure flow abnormality?” is performed by the program, that is, a module for an economizer or primary economizer, secondary economizer and tertiary economizer heating surface soot blower valve fault determination, which is similar as S23, is performed.

S31 implemented by a control unit 331: the program proceeds with a module for “KYQ=AS or A1=AS, A2=AS, A3=AS, . . . , An=AS”, that is, retrieval for the soot blowing alarm signals for all the heating surfaces is performed. Specifically, the program may proceed to S12 when confirmed, that is, the detection of the air pre-heater alarm signal may be performed again to realize intelligent soot blowing cyclic detection and determination, and otherwise the program may enter an air pre-heater time protection soot blowing flow, including S32 to S36.

S32 implemented by a control unit 332: a module for “time elapsed since last soot blowing of KYQ>t0”, that is, a module for determining time elapsed since last soot blowing of the air pre-heater is performed by the program, where t0 may indicate the time elapsed since the last soot blowing of the air pre-heater and may be set in advance according to the unit condition, such as 14400 s, 21600 s, 28800 s, etc. Specifically, when it is confirmed that the time elapsed since last soot blowing of the air pre-heater is longer than a set time, a corresponding soot blowing flow of the air pre-heater may be performed, and otherwise, the soot blowing flow of the heating surface may be skipped.

S33 implemented by a control unit 333: “Is KYQ engaged?”, that is, a module for confirming the engagement of the air pre-heater heating surface soot blower group, which may be consistent with S13, is performed by the program.

S34 implemented by a control unit 334: the module for the KYQ blowing pipeline heating temperature or draining time setting and drain valve DVK closing after draining, which may be consistent with S14, is performed by the program.

S35 implemented by a control unit 335: the module for the KYQ soot blowing pressure and soot blowing time setting, which may be consistent with S15, is performed by the program.

S36 implemented by a control unit 336: the module for starting KYQ soot blower group, which may be consistent with S16, is performed by the program.

S37 implemented by a control unit 337: “close the main steam valve (MSV)”. Specifically, the program may automatically close the main steam valve when there is no heating surface alarm, time of soot blowing for the air pre-heater does not go beyond the set time interval, no air pre-heater heating surface soot blower group is engaged, the operation load does not meet a set condition, and the main steam valve is not opened at the exact position.

S38 implemented by a control unit 338: the main steam valve valve-fault determination module, which may be consistent with S10.

S39 implemented by a control unit 339: a flow of “closing the main steam valve (MSV) at the exact position and opening the drain valves DVA1, DVA2, DVA3, DVAn and DVK” is performed by the program, that is, a flow of closing the main steam valve (MSV) at the exact position and opening drain valves of soot blowing pipelines of all the heating surfaces is performed. Specifically, the program may send an instruction of closing at the exact position to the main steam valve (MSV), determine a state of closing at the exact position, and open the drain valves of the soot blowing pipelines of all the heating surfaces after the main steam valve is closed at the exact position.

S40 implemented by a control unit 340: a drain valve valve-fault determination module. Specifically, whether there are the valve faults on the drain valves of the soot blowing pipelines of all the heating surfaces may be determined. The interrupt processing and resetting after the processing may be performed when there is the fault. The drain valve may be opened when there is no fault or after resetting, to complete a first-round control flow of the closed-loop control system for intelligent soot blowing. Then the program returns to the start state, to prepare for starting a new round of the control flow of the closed-loop control system for intelligent soot blowing.

What is claimed is:

1. A closed-loop control system for intelligent soot blowing of a utility boiler, comprising an intelligent soot blowing server, a distributed control system (DCS), a physical isolation device, a client and a heating surface soot blower group, wherein the intelligent soot blowing server communicates with the DCS via the physical isolation device, reads data from the DCS, and sends a soot blowing alarm signal or a soot blowing control signal to the DCS after processing the data; the client and the heating surface soot blower group establish communication links with the DCS separately; a program and a control flow of the closed-loop control system for intelligent soot blowing are developed; the program is installed in an intelligent soot blowing server or in the DCS; a time protection soot blowing flow for a heating surface of an air pre-heater is set in the control flow; a screen of the closed-loop control system for intelligent soot blowing is set up and installed in the DCS; and cyclic detection of an intelligent soot blowing alarm signal, sequential, cyclic and full-automatic closed-loop control and manual control of soot blowing for the heating surface soot blower group, and double safety control of soot blowing on the heating surface of the air pre-heater are realized by interaction between the screen and the program of the closed-loop control system for intelligent soot blowing, thereby realizing safe and efficient operation of the intelligent soot blowing of the boiler.

2. The closed-loop control system for intelligent soot blowing of the utility boiler according to claim 1, wherein the set-up screen of the closed-loop control system for intelligent soot blowing comprises: an alarm screen for a heating surface of a water wall located in a hearth, alarm screens for heating surfaces of a wall type reheater or a wall type superheater, a platen or division panel superheater, a rear platen or secondary superheater and a rear platen or secondary reheater which are located at top of the hearth, alarm screens for heating surfaces of a high-temperature or final superheater and a high-temperature or final reheater which are located at a horizontal flue, alarm screens for heating surfaces of a low-temperature or primary reheater, a low-temperature or primary superheater, an economizer or a primary economizer, a secondary economizer and a tertiary economizer and the air pre-heater which are located at a tail shaft flue, a soot blowing operation interactive screen and a flue gas flow direction sign; in the soot blowing operation interactive screen, soot blowing alarm labels and alarm lights of the heating surfaces are separately set, engagement and disengagement buttons are set behind the corresponding alarm lights, and the engagement and disengagement buttons for all the heating surfaces are set; when the alarm light of the heating surface gives an alarm, the corresponding heating surface changes in color synchronously to raise an alarm; in the soot blowing operation interactive screen, labels and alarm lights for an initial condition, a soot blower setting, intelligent soot blowing operation, and an intelligent soot blowing fault, start and reset buttons, a main steam valve and an auxiliary steam valve, labels, valve symbols, draining time displays and draining temperature displays of drain valves corresponding to the heating surfaces are further set; the set engagement and disengagement buttons, the start and reset buttons, and the valve symbols can be operated in advance or online in real time by clicking a mouse to interact with the program of the closed-loop control system for intelligent soot blowing, to realize working state switching between engagement and disengagement, start and reset, and opening and closing of a valve; and the buttons and the valves in a working state change in color to be differentiated from the buttons in a non-working state.

3. The closed-loop control system for intelligent soot blowing of the utility boiler according to claim 1, wherein the control flow of the closed-loop control system for intelligent soot blowing is based on a boiler structure and a heating surface setting, according to a sequence of the heating surface of the air pre-heater, the heating surface of the water wall, the heating surfaces of the wall type reheater or wall type superheater, the platen or division panel superheater, the rear platen or secondary superheater, and the rear platen or secondary reheater, the heating surfaces of the high-temperature or final superheater and the high-temperature or final reheater, and the heating surfaces of the low-temperature or primary reheater, the low-temperature or primary superheater, and the economizer or the primary economizer, the secondary economizer and the tertiary economizer, control over a soot blowing alarm signal retrieval module, a soot blower group engagement confirmation module, a module for soot blowing pipeline heating temperature or draining time setting and drain valve closing after draining, a soot blowing pressure and soot blowing time setting module, a heating surface soot blower starting module, and a heating surface soot blower valve fault determination module is sequentially performed, to realize the soot blowing alarm signal retrieval, the soot blowing determination, and engagement operation of the heating surface soot blower group for all the heating surfaces according to the flue gas flow direction of the boiler, with the heating surfaces which do not meet an operation load condition, a valve opening and an alarm condition being skipped, so as to realize sequential control of the intelligent soot blowing for all the heating surfaces; and after soot blowing of the last heating surface, which is the heating surface of the economizer or the primary economizer, the secondary economizer and the tertiary economizer, is skipped or finished, the soot blowing alarm signal retrieval for all the heating surfaces is performed again by the program, and a next flow of alarm signal sequential detection, determination and soot blowing operation for all the heating surfaces is sequentially performed according to the soot blowing alarm signal of the heating surface, to realize cyclic control of the intelligent soot blowing.

4. The closed-loop control system for intelligent soot blowing of the utility boiler according to claim 1, wherein in the control flow of the closed-loop control system for intelligent soot blowing, after the flow of alarm signal sequential detection, determination and soot blowing operation for all the heating surfaces is completed, an air pre-heater heating surface time protection soot blowing flow is started, to realize the double safety protection of soot blowing on the heating surface of the air pre-heater.

5. The closed-loop control system for intelligent soot blowing of the utility boiler according to claim 1, wherein in the soot blowing operation interactive screen, under a condition that the start button is set to be constantly in a working state, buttons for all the heating surfaces are set in an engagement state, the engagement button for each heating surface after the soot blowing alarm is set in a working state, and the soot blower setting is completed in advance, sequential, cyclic, safe and full-automatic closed-loop control of soot blowing for all the heating surfaces can be realized, otherwise, man-machine interactive control can be realized; and the program control flow of soot blowing with the auxiliary steam valve is consistent with a control flow of soot blowing with the main steam valve.

6. The closed-loop control system for intelligent soot blowing of the utility boiler according to claim 1, wherein the heating surface soot blower group is grouped according to a position of a soot blower in the boiler and a soot blowing effect on the heating surface, and comprises an air pre-heater heating surface soot blower group, a water wall heating surface soot blower group, a wall type reheater or wall type superheater heating surface soot blower group, a platen or division panel superheater heating surface soot blower group, a rear platen or secondary superheater heating surface soot blower group, a rear platen or secondary reheater heating surface soot blower group, a high-temperature or final superheater heating surface soot blower group, a high-temperature or final reheater heating surface soot blower group, a low-temperature or primary reheater heating surface soot blower group, a low-temperature or primary superheater heating surface soot blower group, and an economizer or primary economizer, secondary economizer and tertiary economizer heating surface soot blower group.

7. The closed-loop control system for intelligent soot blowing of the utility boiler according to claim 1, wherein the control flow of the closed-loop control system for intelligent soot blowing comprises the following steps:
S1, start of the program of the closed-loop control system for intelligent soot blowing: clicking on the start button in the soot blowing operation interactive screen to start the program, or clicking on the reset button to restore the program to an initial condition;
S2, initial condition detection: performing the initial condition detection after starting the program, wherein the initial condition comprises whether or not soot blowers corresponding to all the heating surfaces are in situ, whether or not the main steam valve and the auxiliary steam valve are closed at the exact position, whether or not drain valves of soot blower pipelines corresponding to all the heating surfaces are opened at the exact position, and that no other equipment fault alarm signals exist except the soot blowing alarm signal; when the initial condition is met, the alarm light for the initial condition is turned on, and the program proceeds to the next step, and when the initial condition is not met, the alarm light for the initial condition is turned off, and an operator checks the initial condition;
S3, soot blower setting: reminding, when the alarm light for the soot blower setting is turned on, the operator to perform the soot blower setting, to disengage the heating surface soot blower group that is faulty or does not need soot blowing; and proceeding to the next step by the program after reminding time t>m s; wherein the time m is determined according to a specific number of the soot blowers of the boiler and requirements of the operator, and is programmed in advance;
S4, engagement of an all-heating-surfaces button or an alarm-heating-surface button: proceeding, when the button is in an engagement state, to the next step of the program, or stopping the program when the button is in a disengagement state; wherein the button can be operated in advance or online in real time;
S5, the soot blowing alarm signal retrieval for all the heating surfaces: proceeding with the program when there are one or more heating surfaces send out the soot blowing alarm signals at the same time in the screen, and otherwise stopping the program;
S6, determination of working states of the soot blowers for all the heating surfaces: proceeding with the program when there is an alarm signal but no heating surface subjected to soot blowing, and otherwise stopping the program;
S7, reconfirmation of the start button and the engagement button of the closed-loop control program for intelligent soot blowing: defaulting, by the program, to the previous operation states of the start and engagement buttons; resetting the closed-loop control program for intelligent soot blowing when the reset button is manually operated; and enabling the corresponding heating surface to be in the disengagement state without soot blowing when the disengagement button for all the heating surfaces or the disengagement button for the alarm heating surface is operated;
S8, operation load determination: proceeding with the program when an operation load meets a load set condition, and otherwise stopping the program, wherein the load set condition is determined in advance and programmed according to a unit condition and requirement;
S9, opening of the main steam valve: automatically opening the main steam valve by default when the operation load meets the set condition, and proceeding with the program, wherein the main steam valve can further be manually opened or closed via the mouse;
S10, main steam valve valve-fault determination module, comprising an interrupt processing and resetting flow: performing the interrupt processing and resetting after manual processing when there is a fault; and proceeding with the program when there is no fault;
S11, setting of a drain pressure of the main steam valve: as programmed in advance according to an operation requirement, setting the drain pressure of the main steam valve as 0.8 MPa, 0.9 MPa, 1.0 MPa or 1.1 MPa, or setting the drain pressure of the main steam valve by manually clicking on the valve symbol of the main steam valve during operation;
S12, detection of an air pre-heater alarm signal: firstly detecting, by the program, an air pre-heater heating surface alarm signal, continuing after confirmation of detection, and otherwise skipping an air pre-heater heating surface soot blowing flow, which indicates that the heating surface is not subjected to soot blowing;
S13, confirmation of the engagement of the air pre-heater heating surface soot blower group: reading, by the program, the engagement or disengagement state of the air pre-heater heating surface soot blower group; proceeding with the program when the air pre-heater heating surface soot blower group is in the engagement state, and skipping, by the program, a soot blowing flow for the heating surface when the air pre-heater heating surface soot blower group is in the disengagement state;
S14, performing, by the program, a module for an air pre-heater soot blowing pipeline heating temperature or draining time setting and drain valve closing after draining, wherein the heating temperature or the draining time of the air pre-heater soot blowing pipeline can be set and programmed in advance according to a design requirement and can be modified online in real time; a draining completion signal is sent after draining is completed, the program automatically controls and closes the drain valve of the soot blowing pipeline; in the soot blowing operation interactive screen, the draining time and a draining temperature are displayed behind a draining time sign and a draining temperature sign correspondingly, and color change is displayed when the drain valve is opened or closed;
S15, performing, by the program, a module for an air pre-heater soot blowing pressure and soot blowing time setting; proceeding with the program when the soot blowing pressure of the air pre-heater meets a set requirement, and otherwise stopping the program; wherein the soot blowing pressure and the soot blowing time of the air pre-heater can be set in the program in advance according to the requirement or set online in real time;
S16, performing, by the program, a module for an air pre-heater heating surface soot blower group soot blowing starting; automatically starting, by the program, a valve of an air pre-heater soot blower group to perform the soot blowing sequentially, and finishing the soot blowing and continuing by the program after the soot blowing is performed for the set soot blowing time;
S17, determination of operation load and main steam valve opened at the exact position: proceeding to the next step of the program when the operation load meets a set condition and a main steam valve opening meets a requirement, and otherwise skipping, by the program, soot blowing flows for all the heating surfaces and closing the main steam valve; wherein the load set condition and a maximum continuous rating (MCR) can be determined in advance and programmed according to the unit condition and the design requirement;
S18, retrieval for a water wall heating surface soot blowing alarm signal and no soot blowing on the other heating surfaces: continuing, by the program, a soot blowing flow of the heating surface when there is the soot blowing alarm signal on the heating surface of the water wall and the other heating surfaces are not subjected to soot blowing, and otherwise skipping, by the program, the soot blowing flow of the heating surface;
S19, confirmation of the engagement of a water wall heating surface soot blower group: reading, by the program, the engagement or disengagement state of the water wall heating surface soot blower group, determining whether or not the water wall heating surface soot blower group is in an engagement soot blowing state; performing, by the program, a corresponding soot blowing flow of the heating surface when the water wall heating surface soot blower group is in the engagement state, otherwise skipping, by the program, the soot blowing flow of the heating surface;
S20, performing, by the program, a module for a water wall soot blowing pipeline heating temperature or draining time setting and drain valve closing after draining, wherein the heating temperature or the draining time of the water wall soot blowing pipeline can be set and programmed in advance according to a design requirement and can be modified online in real time; a draining completion signal is sent after draining is completed, the program automatically controls and closes the drain valve of the water wall soot blowing pipeline; in the soot blowing operation interactive screen, the draining time and a draining temperature are displayed behind a draining time sign and a draining temperature sign correspondingly, and color change is displayed when the drain valve is opened or closed;
S21, performing, by the program, a module for a water wall soot blowing pressure and soot blowing time setting: continuing, by the program, a soot blowing flow of the heating surface when the soot blowing pressure of the water wall meets a requirement, and otherwise stopping the program, wherein the soot blowing pressure and the soot blowing time of the water wall can be set in the program in advance according to the requirement or set online in real time;
S22, performing, by the program, a module for a water wall heating surface soot blower group starting: automatically starting, by the program, a valve of the corresponding soot blower group to perform the soot blowing sequentially, and finishing the soot blowing and proceeding with the program after the soot blowing is performed for the soot blowing time;
S23, performing, by the program, a module for a water wall heating surface soot blower valve fault determination: determining whether the valve of the heating surface soot blower is faulty, performing the interrupt processing and resetting after the processing when there is a fault, and finishing soot blowing for the heating surface of the water wall and then proceeding with the program when there is no fault;
S24, retrieval for a wall type reheater or wall type superheater heating surface soot blowing alarm signal and no soot blowing on the other heating surfaces: performing, by the program, a corresponding soot blowing flow of the heating surface soot blower group when there is the soot blowing alarm signal on the heating surface of the wall type reheater or the wall type superheater and the other heating surfaces are not subjected to soot blowing, and otherwise skipping, by the program, the soot blowing flow of the heating surface;
wherein after S24, the control flow further comprises steps between retrieval for the wall type reheater or wall type superheater heating surface soot blowing alarm signal and no soot blowing on the other heating surfaces and retrieval for an economizer or primary economizer, secondary economizer and tertiary economizer heating surface soot blowing alarm signal and no soot blowing on the other heating surfaces, comprising: steps of the soot blowing control flows for the heating surfaces and steps between every two heating surfaces of the wall type reheater or wall type superheater, the platen or division panel superheater, the rear platen or secondary superheater, the rear platen or secondary reheater, the high-temperature or final superheater, the high-temperature or final reheater, the low-temperature or primary reheater, and the low-temperature or primary superheater; wherein the control flow of the soot blowing program for each heating surface is consistent with the control flow of the soot blowing program for the heating surface of the water wall, but relevant parameters for the soot blowing pipeline heating temperature or draining time setting, the soot blowing pressure and soot blowing time setting and flow abnormality in the flow, as well as control signals for the drain valves, the soot blowers and a soot blower fault, should be replaced with those of the corresponding heating surfaces;
S25, retrieval for an economizer or primary economizer, secondary economizer and tertiary economizer heating surface soot blowing alarm signal and no soot blowing on the other heating surfaces: performing, by the program, a corresponding soot blowing flow of the heating surface when there is the soot blowing alarm signal on the heating surface of the economizer or primary economizer, secondary economizer and tertiary economizer and the other heating surfaces are not subjected to soot blowing, and otherwise skipping, by the program, the soot blowing flow of the heating surface to retrieve the soot blowing alarm signals for all the heating surfaces;
S26, confirmation of the engagement of an economizer or primary economizer, secondary economizer and tertiary economizer heating surface soot blower group: continuing, by the program, a corresponding soot blowing flow for the heating surface when the engagement is confirmed, and otherwise skipping, by the program, the soot blowing flow of the heating surface to retrieve the soot blowing alarm signals for all the heating surfaces;
S27, performing, by the program, a module for an economizer or primary economizer, secondary economizer and tertiary economizer soot blowing pipeline heating temperature or draining time setting and drain valve closing after draining, which is similar as S20;
S28, performing, by the program, a module for an economizer or primary economizer, secondary economizer and tertiary economizer soot blowing pressure and soot blowing time setting, which is similar as S21;
S29, performing, by the program, a module for an economizer or primary economizer, secondary economizer and tertiary economizer soot blower starting, which is similar as S22;
S30, performing, by the program, a module for an economizer or primary economizer, secondary economizer and tertiary economizer heating surface soot blower valve fault determination, which is similar as S23;
S31, retrieval for the soot blowing alarm signals for all the heating surfaces: performing S12 by the program when there are one or more heating surfaces send out the soot blowing alarm signals at the same time, that is, performing the detection of the air pre-heater alarm signal again to realize intelligent soot blowing cyclic detection and determination, and otherwise entering, by the program, an air pre-heater time protection soot blowing flow, comprising S32 to S36;
S32, a module for determining a soot blowing time interval between a last soot blowing and a current soot blowing of the air pre-heater: performing the soot blowing flow for the heating surface of the air pre-heater when the time interval is greater than a set time interval, and otherwise skipping the soot blowing flow of the heating surface, wherein the soot blowing time interval can be set in advance according to a condition, for example, can be set as 14400 s, 21600 s, 28800 s, etc.;
S33, performing, by the program, a module for confirming the engagement of the air pre-heater heating surface soot blower group, which is consistent with S13;
S34, performing, by the program, the module for the air pre-heater soot blowing pipeline heating temperature or draining time setting and drain valve closing after draining, which is consistent with S14;
S35, performing, by the program, the module for the air pre-heater soot blowing pressure and soot blowing time setting, which is consistent with S15;
S36, performing, by the program, the module for the air pre-heater soot blowing starting, which is consistent with S16;
S37, closing the main steam valve by the program: automatically closing the main steam valve by the program when there is no heating surface alarm, time of soot blowing for the air pre-heater does not go beyond the set time interval, no air pre-heater heating surface soot blower group is engaged, the operation load does not meet a set condition, and the main steam valve is not opened at the exact position;
S38, performing the main steam valve valve-fault determination module, which is consistent with S10;
S39, performing, by the program, a flow of closing the main steam valve at the exact position and opening drain valves of soot blowing pipelines of all the heating surfaces: sending, by the program, an instruction of closing at the exact position to the main steam valve, determining a state of closing at the exact position, and opening the drain valves of the soot blowing pipelines of all the heating surfaces after the main steam valve is closed at the exact position; and
S40, performing a drain valve valve-fault determination module: determining whether there are the valve faults on the drain valves of the soot blowing pipelines of all the heating surfaces; performing the interrupt processing and resetting after the processing when there is the fault; opening the drain valve when there is no fault or after resetting, to complete a first-round control flow of the closed-loop control system for intelligent soot blowing, then the program returns to the start state, to form a closed-loop control flow of the control system for intelligent soot blowing.
